(19) United States
(12) Patent Application Publication
(10) Pub. No.: US 2018/0320653 A1
(43) Pub. Date: Nov. 8, 2018

(54) EMBEDDED SPRINKLER ACTIVATED GENERATOR

(71) Applicant: JAIN IRRIGATION SYSTEMS LIMITED, Bambhori, Jalgaon (IN)

(72) Inventors: Defrank Michael PATRICK, Pawhuska, OK (US); Jain Ajit BHAVARLAL, Jalgaon (IN)

(21) Appl. No.: 15/524,084

(22) PCT Filed: Nov. 4, 2015
(86) PCT No.: PCT/IN2015/000407

§ 371 Date: May 3, 2017

(30) Foreign Application Priority Data
Nov. 5, 2014 (IN) 3490/MUM/2014

(51) Int. Cl. F03B 3/08; B05B 3/06

(52) U.S. Cl. CPC F03B 3/08; B05B 3/0486; B05B 3/06

(57) ABSTRACT

Disclosed is an embedded sprinkler system. The embedded sprinkler system comprises a stator, and a rotor, embedded in the embedded sprinkler system. The rotor may further be integrated with a sprinkler arm. Further the sprinkler arm may be connected to a nozzle allowing for a fluid to flow through. The sprinkler arm may inherently have an angle.

### TECHNICAL FIELD

The present subject matter described herein, in general, relates to a sprinkler, and more particularly to a sprinkler configured to conserve energy.

### BACKGROUND

Presently sprinklers embedded with generator are being used to harvest energy from flowing water. They convert the kinetic energy of the flowing water to electric energy thus conversing energy.

However, the current design of sprinklers configured to harvest energy has limitation on torque obtained and length of the rotor arm. Therefore, to generate more energy more torque is required, and since the torque obtained is inversely proportional to the length of the rotor arm, one needs to longer rotor arm. Thus increasing the overall size of the system.

Hence, it may be desirable to obtain larger torque in a system without increasing the size of the entire system or sprinkler housing.

### SUMMARY

This summary is provided to introduce aspects related to an embedded sprinkler system and the aspects are further described below in the detailed description. This summary is not intended to identify essential features of the claimed subject matter nor is it intended for use in determining or limiting the scope of the claimed subject matter.

In one implementation an embedded sprinkler system is disclosed. The system may comprise a sprinkler arm. Further a generator rotor may be directly mounted and integrated on the sprinkler arm. Further the system may comprise a generator stator enclosed around the generator rotor. Further a printed circuit board housing enclosing the generator stator.

In another implementation an embedded sprinkler system is disclosed. The system comprising a generator rotor mounted on a sprinkler arm characterized wherein the generator rotor is integrated with the sprinkler arm without a housing for the generator rotor. Further may comprise of a generator stator enclosed around the generator rotor. Further the system may comprise of a printed circuit board housing enclosing the generator stator.

In another implementation a method to assemble an embedded sprinklers system. The method comprising mounting a generator rotor directly on a sprinkler arm. Further the method comprises enclosing the generator rotor with a generator stator. The method may further comprise enabling a fluid flow from a nozzle to atmosphere via the sprinkler arm.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a prior art.

FIG. 2a illustrates front view of an embedded sprinkler system, in accordance with an embodiment of the present subject matter.

FIG. 2b illustrates section view of an embedded sprinkler system, in accordance with an embodiment of the present subject matter.

FIG. 3 illustrates a flow chart for assembling an embedded sprinkler system, in accordance with an embodiment of the present subject matter.

### DETAILED DESCRIPTION

The present subject matter discloses an embedded sprinkler system configured to harvest energy.

U.S. Pat. No. 6,864,591, Titled “Sprinkler Activated Generator” and Indian Patent application 3142/MUM/2012, Titled “Motion Control System and Method of Energy Harvesting” are incorporated herein by reference.

The present subject matter discloses an embedded sprinkler system. The embedded sprinkler system of the present disclosure may be configured to convert hydraulic energy to electrical energy. The embedded sprinkler system disclosed may be configured to obtain higher torque without increasing the size of the entire system. The present disclosure will further enable wider selection of generator designs for a sprinkler system to generate/harvest maximum energy.

The embedded sprinkler system of the present disclosure embeds a stator and rotor directly into a sprinkler system. The rotor may be integrated with a sprinkler arm. The sprinkler arm can be further coupled to a nozzle. The sprinkler arm may be angled. Further, the stator may be enclosed around the rotor. Thus allowing for a torque arm to be as long as desired enabling broader motor design to overcome initial torque required.

Further the embedded sprinkler system may comprise of a thin film board connected to a power source.

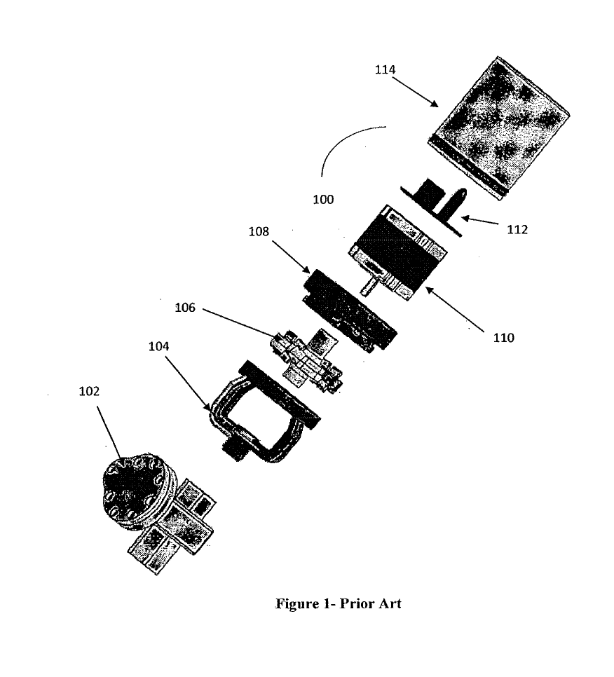

Referring to FIG. 1, a perspective view of a sprinkler 100, in accordance with an embodiment of the present subject matter. The sprinkler 100 may comprise a gate valve 102. Further, the sprinkler 100 may comprise a sprinkler frame 104, mounted on the gate valve 102. The sprinkler frame 104 may comprise a plurality of connecting wires. A rotor 106 may be mounted on the sprinkler frame 104. The rotor 106, may be configured to be mechanically coupled to a generator 110, wherein a generator base 108 may be sandwiched between the rotor 106 and the generator 110.

The sprinkler 100 may further comprise of an electronic component 112. The electronic component may further comprise of an embedded sensor, a memory module with pre-defined set of instructions and a means for communication.

According an exemplary embodiment the sprinkler 100 can be housed in a housing 114.

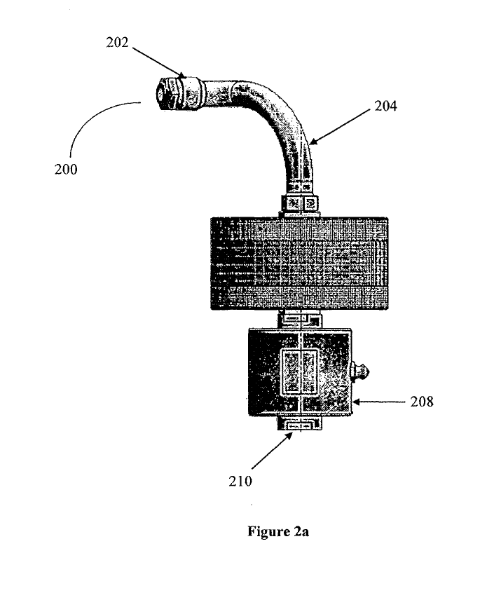

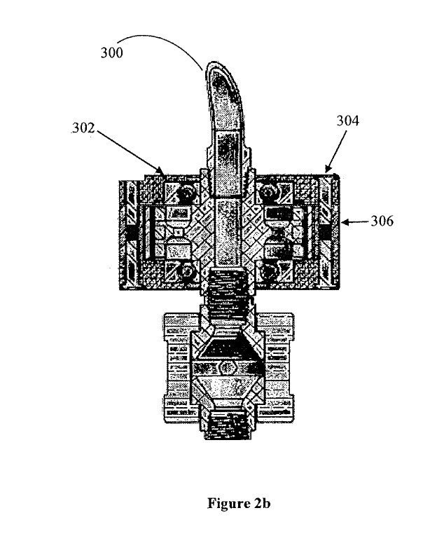

FIG. 2a illustrates front view of an embedded sprinkler system 200, in accordance with an embodiment of the present subject matter. The embedded sprinkler system 200, may comprise nozzle 202. The nozzle 202 may be further connected a sprinkler arm 204. Further the embedded sprinkler system 200, may comprise of a rotary unit 208. The rotary unit 208 may be mounted on a gate valve 210.

FIG. 2b illustrates section view of an embedded sprinkler system 300, in accordance with an embodiment of the present subject matter. The embedded sprinkler system 300, may comprise a generator rotor 302 enclosed in a generator stator 304. Further, the embedded sprinkler system 300, may comprise a printed circuit board (PCB) housing 306 enclosing the generator stator 304.

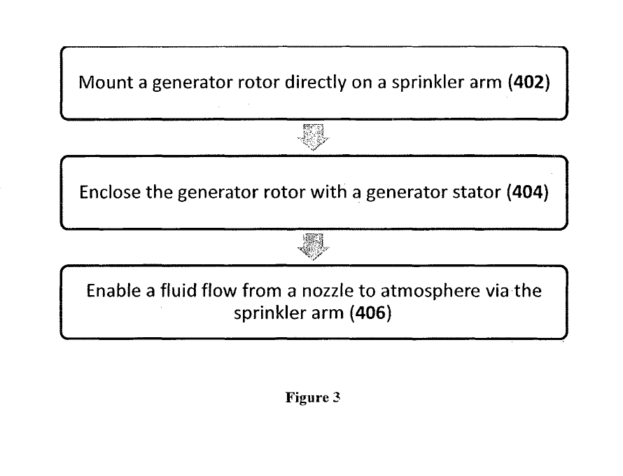

Now referring to FIG. 3, illustrates a flow chart for assembling an embedded sprinkler system. At step 402 a generator rotor is mounted on a sprinkler arm. The generator rotor may be detachably integrated on the sprinkler arm. The generator rotor may be screwed on the sprinkler arm. The mounting of the generator rotor directly on the sprinkler arm enables removal of a housing usually present for conventional generators. The generator rotor may be configured to capture the rotating movement of the sprinkler arm and convert the motion into energy for power generation.

Further at step 404, the generator rotor may be enclosed by generator stator. Further at step 406, a fluid flow may be enabled from a nozzle via the sprinkler arm.

I/We claim:

1. An embedded sprinkler system, comprising:
a sprinkler arm;
a generator rotor directly mounted and integrated on the sprinkler arm;
a generator stator enclosed around the generator rotor; and
a printed circuit board housing enclosing the generator stator.

2. The embedded sprinkler system as claimed in claim 1, further comprises a nozzle mounted on the sprinkler arm at a first end.

3. The embedded sprinkler system as claimed in claim 1, further comprises a rotary unit mounted on the sprinkler arm at a second end opposite to the first end.

4. The embedded sprinkler system as claimed in claim 1, further comprises a gate valve mounted below the rotary unit.

5. An embedded sprinkler system, comprising a generator rotor mounted on a sprinkler arm characterized wherein the generator rotor is integrated with the sprinkler arm without a housing for the generator rotor;
a generator stator enclosed around the generator rotor; and
a printed circuit board housing enclosing the generator stator.

6. The embedded sprinkler system of the claim 5, wherein the generator rotor is detachably mounted on the sprinkler arm.

7. The embedded sprinkler system as claimed in claim 5, further comprises a nozzle mounted on the sprinkler arm at a first end.

8. The embedded sprinkler system as claimed in claim 5, further comprises a rotary unit mounted on the sprinkler arm at a second end opposite to the first end.

9. The embedded sprinkler system as claimed in claim 5, further comprises a gate valve mounted below the rotary unit.

10. A method to assemble an embedded sprinkler system, the method comprising:
mounting a generator rotor directly on a sprinkler arm;
enclosing the generator rotor with a generator stator; and
enabling a fluid flow from a nozzle to atmosphere via the sprinkler arm.

11. The method of claim 10, further comprises capturing a rotating movement of the sprinkler arm during the fluid flow via the generator rotor.

12. The method of claim 11, further comprises generation of power from the captured rotating movement.

13. The method of claim 10, further comprises wirelessly controlling and monitoring the generator rotor.
